(19) United States
(12) Patent Application Publication
(10) Pub. No.: US 2006/0158737 A1
(43) Pub. Date: Jul. 20, 2006

(54) Tamper-Proof Content-Playback System Offering Excellent Copyright Protection

(76) Inventors: Chenming HU, Alamo, CA (US); Guobiao ZHANG, Stateline, NV (US)

Correspondence Address: GUOBIAO ZHANG, P.O. BOX 6182, STATELINE, NV, 89449-6182, US

(21) Appl. No.: 10/906,609

(22) Filed: Feb. 25, 2005

Related U.S. Application Data
(60) Provisional application No. 60/593,499, filed on Jan. 19, 2005.
(60) Provisional application No. 60/593,806, filed on Feb. 15, 2005.

(51) Int. Cl. H04N 5/91

(52) U.S. Cl. 359/566

(57) ABSTRACT

To protect copyright, the present invention provides a tamper-proof content-playback system. Its content-playback unit has the following I/O characteristics: A) at least a portion of its content input(s) is encrypted digital signals; B) at least a portion of its content output(s) is non-digital (e.g. analog) or non-electrical (e.g. image) signals. Only secure data connections are allowed for decrypted contents inside the content-playback unit. Accordingly, its components are preferably integrated into: a single chip, a single package, or a chip/package-on-panel.

### CROSS-REFERENCE TO RELATED APPLICATIONS

This patent application relates to a provisional patent application “Content-playing chip and system offering excellent copyright protection”, Provisional Application No. 60/593,499, Filed Jan. 19, 2005; it also relates to a provisional patent application “Content-playback chip, package and system offering excellent copyright protection”, Provisional Application No. 60/593,806, Filed Feb. 15, 2005.

### BACKGROUND

1. Technical Field of the Invention

The present invention relates to the field of integrated circuits and system, and more particularly to tamper-proof content-playback system offering excellent copyright protection.

2. Prior Arts

ipod (from Apple) and other digital content players (e.g. digital print media, digital audio player, digital image player, and digital video player) are gaining popularity recently. FIG. 1 is a block diagram of an ipod. It is comprised of a storage 02, a data decompressor 04 (a.k.a. digital signal processor, e.g. an Mp3 decoder from PortalPlayer), a data converter 06 (e.g. a DAC from Wolfson) and a speaker (or earphone) 08. The storage 02 stores the contents-to-be-played 10. It typically comprises a hard-disk drive (HDD), or a flash memory. During playback, a content file 2 is read out to the Mp3 decoder 04 and decompressed. The decompressed data 16 is then converted into analog signals by the DAC 06. Because storage 02, Mp3 decoder 04 and DAC 06 are implemented in discrete packages, pirates may intercept the content information by probing the PCB (printed circuit board) wires between them, i.e. at locations 10, 12, and/or 16. Because information at these locations is all digital and can be copied digitally (digital copying does not degrade the content quality), a pirated copy will be a “perfect” copy. As a result, copyright protection is weak for the ipod. For the same reason, other digital content players (e.g. DVD player, which has a similar construct as ipod) lack strong copyright protection. Accordingly, the present invention provides tamper-proof content-playback system offering excellent copyright protection.

### OBJECTS AND ADVANTAGES

It is a principle object of the present invention to provide a tamper-proof content-playback system that offers excellent copyright protection.

It is a further object of the present invention to provide tamper-proof content-playback system with improved power efficiency and low cost.

It is a further object of the present invention to provide a tamper-proof content-playback system that fulfills various DRM (digital rights management) requirements.

In accordance with these and other objects of the present invention, a tamper-proof content-playback system offering excellent copyright protection is disclosed.

### SUMMARY OF THE INVENTION

The present invention provides a tamper-proof content-playback system. It comprises a content-storage unit and a content-playback unit. The content storage unit may be embedded in the content-playback unit or separate therefrom. At least a portion of the content files stored therein are encrypted.

The content-playback unit has the following I/O characteristics:
A) at least a portion of its content input(s) is encrypted digital signals;
B) at least a portion of its content output(s) is non-digital electrical (e.g. analog) signals or non-electrical (e.g. image) signals.
   These I/O characteristics guarantee excellent copyright protection, because: A) encrypted contents, even though intercepted, are meaningless without the key; B) copying of non-digital/non-electrical signals (e.g. by re-digitizing them) degrade content quality and cannot generate “perfect” digital copy. To obtain these I/O characteristics, the content-playback unit should at least comprise a decryption engine (for decrypting the encrypted content inputs) and a data converter (for converting digital contents into non-digital/non-electrical signals).

To be tamper-proof, the content-playback unit should be built in such a way that its internal data connections carrying decrypted contents are free from snooping. Data connections that can be externally accessed to copy decrypted contents readily should be prohibited. For example, because they can be easily snooped upon, unprotected PCB wires are preferably avoided internally. Accordingly, only secure data connections are allowed for decrypted contents inside the content-playback unit. Secure data connections do not provide ready external access to decrypted contents. They include chip interconnects, bond wires, solder bumps, and/or protected PCB wires. Moreover, the content-playback unit may be further protected by encapsulation with a molding compound; and at least some solder bumps carrying plaintext data should preferably be placed in the interior rather than near the edge of a flip-bonded chip to foil attempts to snoop the data. In sum, the content-playback unit should be highly integrated. Its components (e.g. decryption engine, data converter) are preferably integrated into: A) a single chip; B) a single package; or C) a chip/package-on-panel. Here, chip/package-on-panel means that a chip or a package (e.g. decryption engine) is directly mounted onto a display panel (e.g. data converter). Choice A) (i.e. single chip integration, or a content-playback chip) offers the best copyright protection, because interconnects inside a chip are almost impossible to be snooped upon. In a content-playback chip, to further prevent snooping using sophisticated techniques such as e-beam probing, at least a portion of decrypted contents are preferably carried in the interconnect levels lower than the top level.

For content-playback units under power and cost constraints, a data decompressor (a.k.a. digital signal processor) preferably can be integrated into and placed between the decryption engine and data converter. As a result, only compressed data need to be decrypted. Because compressed data runs at a much lower speed (relative to decompressed data) and its decryption is computationally less expensive (than the decryption of decompressed data), the content-playback unit integrated with the data decompressor would consume less power and cost less.

The content-playback unit further comprises a player ID. The player ID is a unique number and is used by a content-key provider to identify if this content-playback unit is an approved device (i.e. authorized to receive copyrighted contents, e.g. a tamper-proof device). The player ID comprises highly-sensitive information and should be tightly guarded: only secure data connections are allowed between the storage of player ID and other portion of the content-playback unit. Preferably, the storage of player ID is embedded into the content-playback unit (e.g. in a same chip or package).

### BRIEF DESCRIPTION OF THE DRAWINGS

FIG. 1 is a block diagram of an ipod (prior art);

FIG. 2 is a block diagram of a preferred tamper-proof content-playback system offering excellent copyright protection;

FIG. 3 illustrates the content arrangement in a preferred content storage;

FIG. 4 is a block diagram of a preferred tamper-proof content-playback unit offering excellent copyright protection;

FIGS. 5A-5D illustrate several preferred data converters;

FIGS. 6A-6C illustrate several preferred tamper-proof content-playback chips offering excellent copyright protection;

FIGS. 7A-7C illustrate several preferred tamper-proof content-playback packages offering excellent copyright protection;

FIG. 8 illustrates a preferred tamper-proof content-playback chip/package-on-panel offering excellent copyright protection.

FIG. 9 illustrates a preferred tamper-proof content-delivery process and associated hardwares;

FIG. 10A explains conditional access specified by digital rights management (DRM); FIG. 106B illustrates a preferred tamper-proof content-playback system that provides conditional access to contents;

FIG. 11A explains fair-use rights specified by DRM; FIG. 11B illustrates a preferred tamper-proof content-playback system that protects the fair-use rights of consumers.

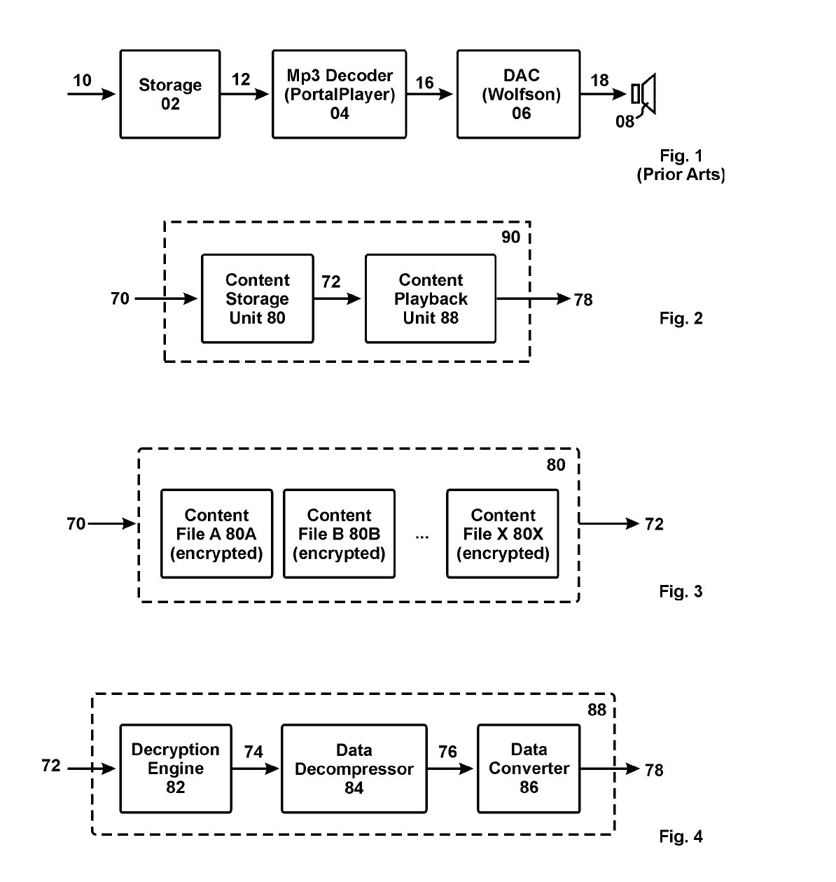

### DETAILED DESCRIPTION OF THE PREFERRED EMBODIMENTS

Those of ordinary skills in the art will realize that the following description of the present invention is illustrative only and is not intended to be in any way limiting. Other embodiments of the invention will readily suggest themselves to such skilled persons from an examination of the within disclosure.

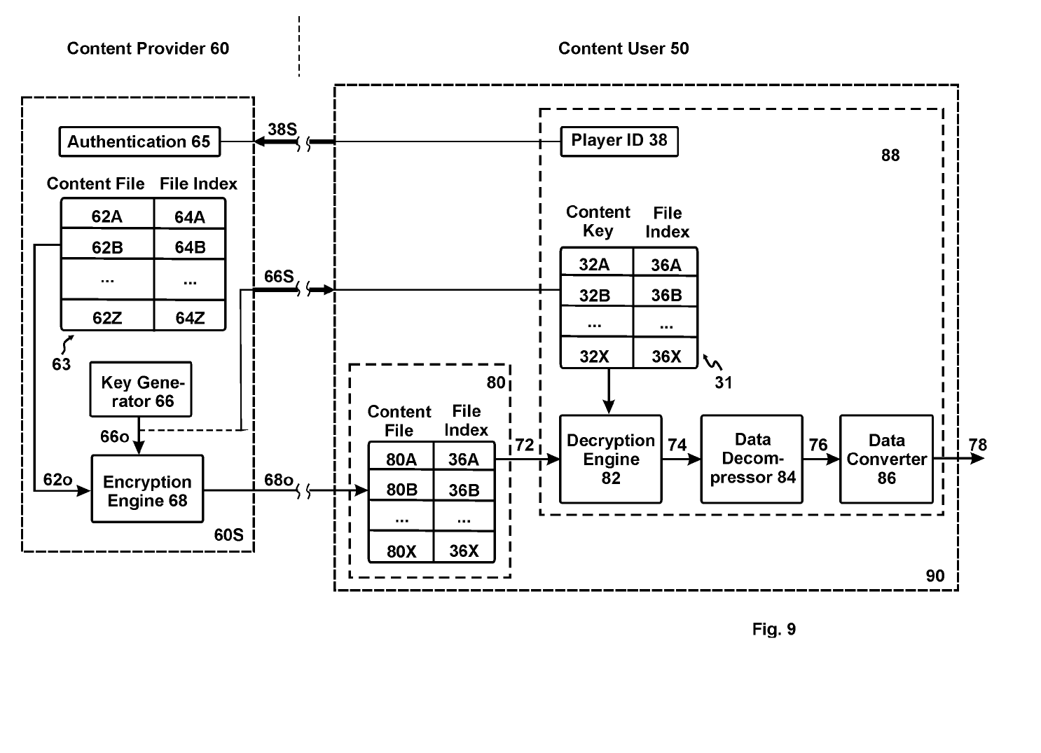

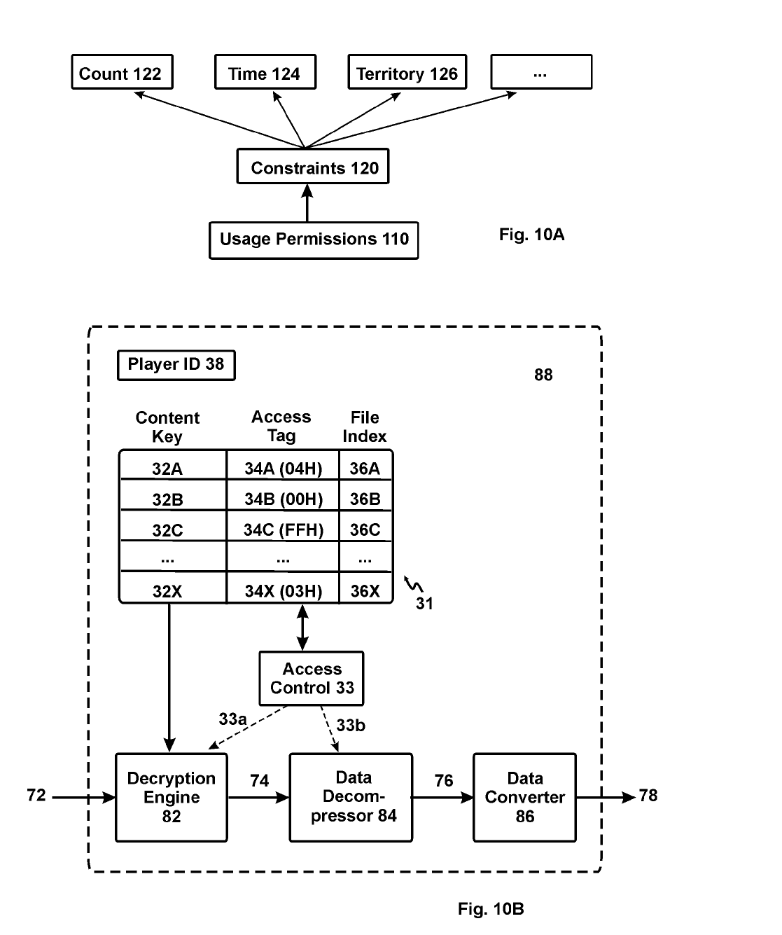

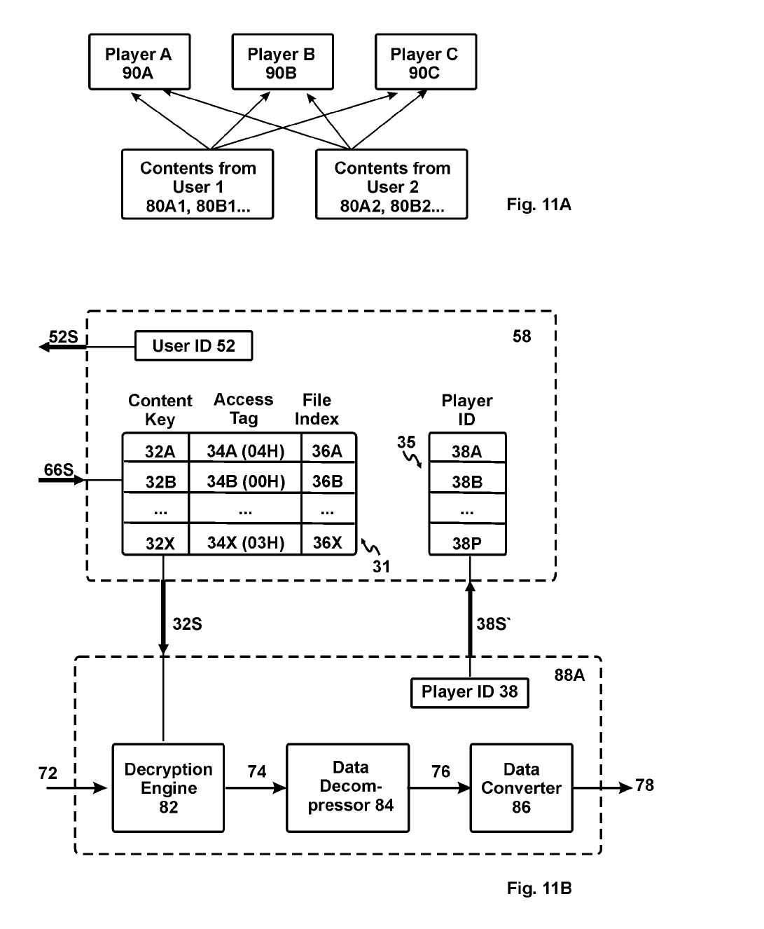

FIGS. 2-4 disclose details on a preferred tamper-proof content-playback system 90. It is comprised of a content storage unit 80 and a content-playback unit 88 (FIG. 2). The content storage unit 80 may be embedded in the content-playback unit 88 or separate therefrom. It could be tape, optical disk, magnetic disk, flash memory and other semiconductor memories. At least a portion of the content files (80A, 80B . . . ) stored in the storage 80 are encrypted (at least selectively encrypted) (FIG. 3). Being encrypted, content files are meaningless, even if the content storage unit is comprised. They can only be played back after the associated content keys are obtained from the content provider (referring to FIG. 9).

The tamper-proof content-playback unit 88 has the following I/O characteristics:
A) at least a portion of its content input(s) 72 is encrypted digital signals;
B) at least a portion of its content output(s) 78 is non-digital electrical (e.g. analog) signals or non-electrical (e.g. image) signals.
   These I/O characteristics guarantee excellent copyright protection, because: A) encrypted contents, even though intercepted, are meaningless without the key; B) copying of non-digital/non-electrical signals (e.g. by re-digitizing analog or image signals) degrade content quality and cannot generate “perfect” digital copy. To obtain these I/O characteristics, the content-playback unit should at least comprise a decryption engine and a data converter.

Referring now to FIG. 4, a block diagram of a preferred tamper-proof content-playback unit 88 is illustrated. It comprises a decryption engine 82, a data decompressor 84 (if the inputted data has been compressed) and a data converter 86. The decryption engine 82 decrypts the encrypted content input(s) 72 into decrypted contents 74. The data decompressor 84 could be a form of digital signal processor (DSP). It decompresses these decrypted contents 74 into a decompressed form 76. It could be a digital text decoder, digital audio decoder (e.g. Mp3 decoder), or a digital image decoder (e.g. digital still image decoder such as jpeg decoder, digital video decoder such as mpeg decoder). It can help lower the power consumption and reduce the design complexity. The data converter 86 further converts these decompressed contents 76 into non-digital (e.g. analog) signals or non-electrical (e.g. image) signals 78. The non-digital (e.g. analog) signals are then fed into an audio/video device (e.g. speaker/display) for human perception; the non-electrical (e.g. image) signals may be directly perceived by a person. Note that a content-playback unit 88 may just comprise a decryption engine 82 and a data converter 86.

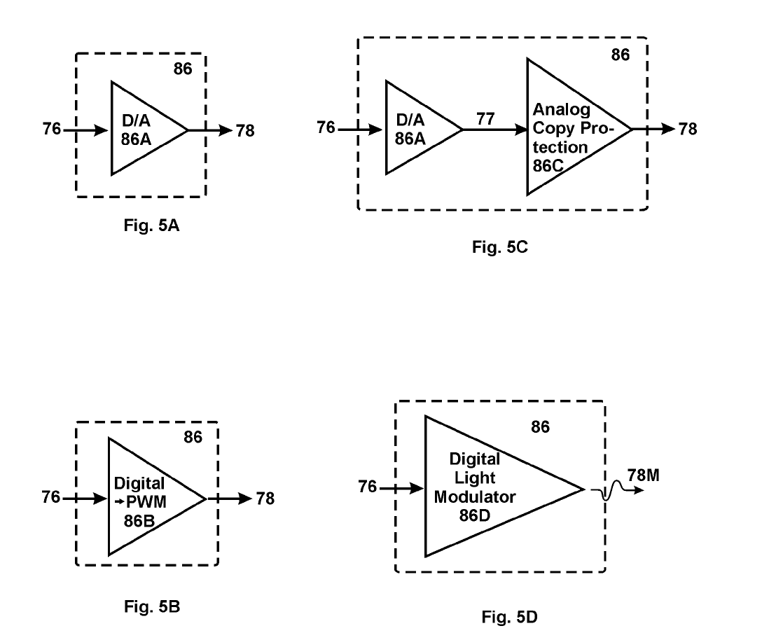

Depending on its output(s), the data converter can be categorized into digital-to-non-digital converter (DNDC) and digital-to-non-electrical converter (DNEC). DNDC converts digital contents to non-digital signals, typically analog signals. Analog signals could be either in a voltage domain or in a time domain. Analog signals in the voltage domain are commonly used by audio devices to create sound. On the other hand, analog signals in the time domain—PWM (pulse-width modulation) signal or PPM (pulse-position modulation) signal—is commonly used by video devices to create images. FIGS. 5A-5C illustrate three preferred DNDC's: the first one is a conventional digital-to-analog converter (DAC) 86A (FIG. 5A); the second one is a digital-to-PWM converter 86B (i.e. a time-domain DAC) (FIG. 5B); the third one further comprises an analog copy protection circuit 86C (FIG. 5C). The analog copy protection circuit 86C modified the analog output 77 from the DAC 86A. The modified analog output 78 can be used to drive audio/video devices, but not suitable for making un-authorized copies. Examples of analog copy protection circuit 86C are disclosed in U.S. Pat. No. 4,631,603, “Method and apparatus for processing a video signal so as to prohibit the making of acceptable video tape recording thereof”, by Ryan, Issued Dec. 23, 1986.

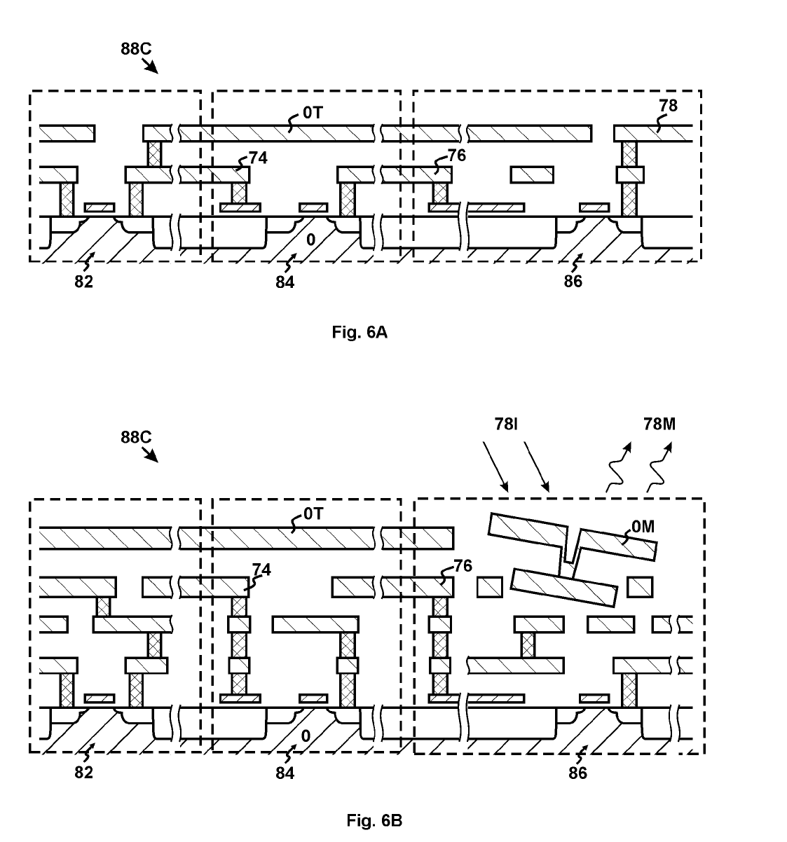

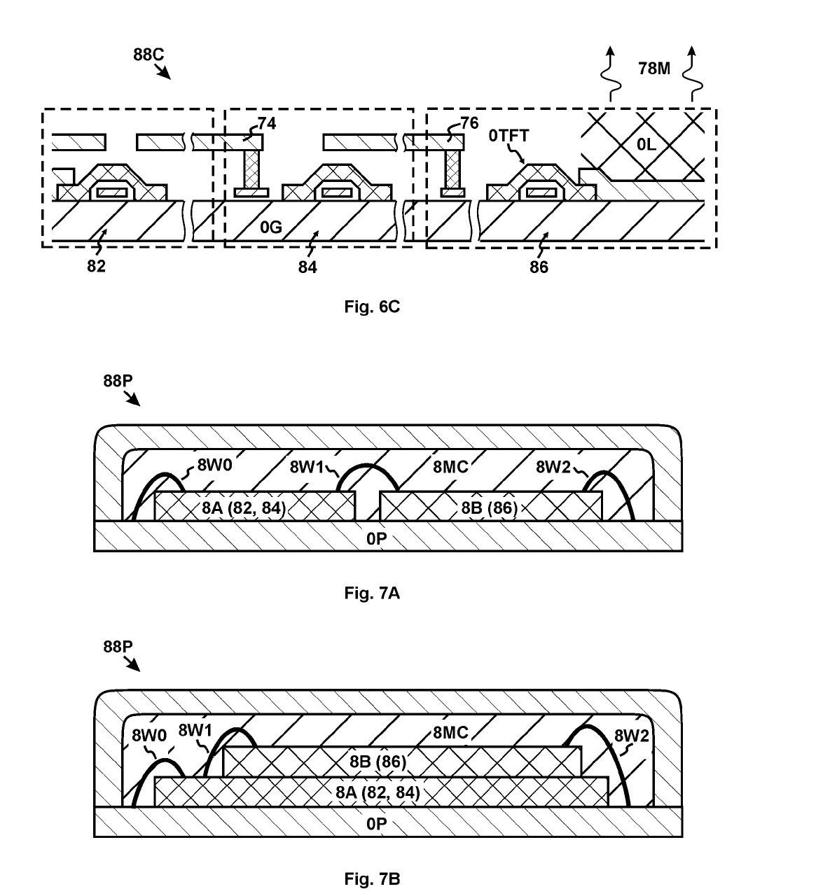

DNEC converts digital contents into non-electrical signals. DNEC can be categorized into digital loudspeaker and digital light modulator 86D (FIG. 5D). Digital loudspeaker directly converts digital contents into sound. It could be silicon-based and can be readily integrated with other integrated circuits (e.g. decryption engine, data decompressor) (referring to U.S. Pat. No. 6,829,131, “MEMS digital-to-acoustic transducer with error cancellation”, by Leob et al., Issued Dec. 7, 2004). On the other hand, digital light modulator directly converts digital contents 76 into images 78M (i.e. modulated light). To make a copy of contents (e.g. a video, a movie), pirates need to use a camcorder to capture the on-screen images and re-digitize them. This process can significantly degrade the content quality. As a result, DNEC offers superior copyright protection. Digital light modulators can be categorized into micro-display and display panel. Micro-displays have small size (˜cm), whereas display panels have regular (large) size. As will be explained in FIG. 6B, micro-displays are suitable for integration with digital IC (e.g. decryption engine 82, data decompressor 84) and therefore, provide near-perfect copyright protection. Examples include displays using moving optical elements or moving gratings such as DMD (digital micro-mirror device, which is used in the DLP of Texas Instruments, referring to U.S. Pat. No. 4,441,791, “Deformable mirror light modulator”, by Hornbeck, Issued Apr. 10, 1984) and scanned beam display (from Microvision Inc.), small display using liquid crystal to modulate light such as LCoS (liquid crystal on silicon), light-emitting diode array and others. On the other hand, display panels include LCD display, plasma display, organic light-emitting-diode display and others. They can be used to form chip/package-on-panel, as will be illustrated in FIG. 8.

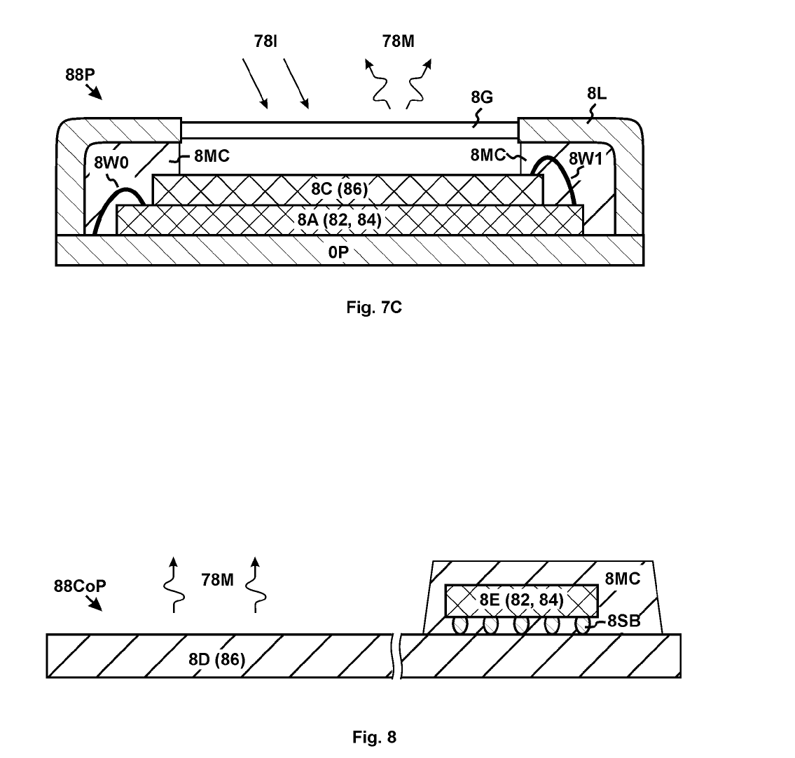

To be tamper-proof, the content-playback unit 88 should be built in such a way that its internal data connections carrying decrypted contents are free from snooping. Data connections that can be externally accessed to copy decrypted contents readily should be prohibited. For example, because they can be easily snooped upon, unprotected PCB wires are preferably avoided internally. Accordingly, only secure data connections are allowed for decrypted contents inside the content-playback unit. Secure data connections do not provide ready external access to decrypted contents. They include chip interconnects, bond wires, solder bumps, and/or protected PCB wires. Moreover, the content-playback unit 88 may be further protected by encapsulation with a molding compound; and at least some solder bumps carrying plaintext data should preferably be placed in the interior rather than near the edge of a flip-bonded chip to foil attempts to snoop the data (see below). In sum, the content-playback unit should be highly integrated. Its components are preferably integrated into: A) a single chip (FIGS. 6A-6C); B) a single package (FIGS. 7A-7C); or, C) a chip/package-on-panel (FIG. 8). Choice A) (i.e. single chip integration, or a content-playback chip) offers the best copyright protection, because chip interconnects are almost impossible to be snooped upon. In a content-playback chip, to further prevent snooping using sophisticated techniques such as e-beam probing, at least a portion of decrypted contents are preferably carried in the interconnect levels lower than the top level.

The content-playback unit may be further protected by encapsulation with a molding compound. Attempts to remove the molding compound to gain access to data connections such as the bond wires and PCB wires for snooping purpose will likely damage the fragile wires or otherwise render the unit unfunctional and snooping unsuccessful. Also, some of the solder bumps carrying plaintext data should preferably be placed in the interior rather than at the edge of a flip-bonded chip to foil attempts to snoop the data. Because the data rate is high, the data quantity is large, and the damageable connections are numerous, these means of protection will be quite effective in preventing the making of a perfect copy.

Referring now to FIGS. 6A-6C, three preferred content-playback chips 88C are illustrated. Each of the preferred content-playback chips integrates the decryption engine 82, data decompressor 84 (if the inputted data has been compressed) and data converter 86 into a single chip substrate 0. Because chip interconnects are almost impossible to be snooped upon, these preferred embodiments offer superior copyright protection. In FIG. 6A, the preferred data converter 86 is a DNDC. DNDC 86, which is a mixed-signal circuit, and DE2 (shorthand for both decryption engine 82 and data decompressor 84 hereinafter), which is a digital circuit, can be easily integrated into a single chip 88C. To further improve copyright protection, decrypted contents 74, 76 preferably do not flow at the top interconnect level 0T but only flow at lower levels. As a result, even sophisticated techniques such as e-beam probing cannot be used to intercept contents.

FIG. 6B illustrates a single-chip player 88C. Its data converter is one type of DNEC—a micro-display such as a DMD 86. The DMD comprises a tiltable micro-mirror 0M, whose outgoing light 78M is modulated by reflecting the incoming light 78I to different directions. Because it is typically CMOS-based, has a small die size (˜cm) and a manufacturing process compatible with digital IC, DMD (and other types of displays, e.g. displays using moving optical elements or moving gratings, small display using liquid crystal to modulate light such as LCoS, light-emitting diode array) may be integrated with DE2 (82, 84) into a single chip 88C. In sum, the single-chip player 88C offers near-perfect copyright protection: its input(s) is encrypted; its output(s) is image; and all of its electrical connections are embedded inside the chip (similarly, the top interconnect level 0T is preferably not used for decrypted contents 74, 76).

FIG. 6C illustrates a single-panel player 88C. Its data converter is another type of DNEC—a display panel such as an LCD panel 86. The outgoing light 78M is modulated by the orientation of liquid crystal 0L. The LCD panel 86 is built on a glass substrate 0G. The TFT's (thin-film transistor) 0TFT, which are used as controls for liquid crystal, can also be used to form digital parts (e.g. 82, 84). Thus, the DE2 (82, 84) can be integrated with LCD 86 (or other display panels, e.g. plasma display and organic light-emitting-diode display) on a single panel substrate 0G. Similarly, this single-panel player provides excellent copyright protection.

Referring now to FIGS. 7A-7C, three preferred content-playback packages 88P are illustrated. Each of the preferred content-playback packages integrates the decryption engine 82, data decompressor 84 (if the inputted data has been compressed) and data converter 86 into a single package (e.g. onto a single interposer substrate 0P). FIG. 7A is a multi-chip package 88P and FIG. 7B is a stacked-die package 88P. Here, DE2 (82, 84) are implemented in one chip 8A and data converter 86 is implemented in another chip 8B. In FIG. 7A, they are placed side-by-side; whereas in FIG. 7B, they are stacked together. Bond wires 8W0, 8W1, 8W2 (or solder bumps) provide electrical connections. Because no un-protected PCB wires are used, this package 88P offers excellent copyright protection, which may be further enhanced by encapsulation with molding compound(s) 8MC.

FIG. 7C illustrates a single-package player. It uses a stacked-die package 88P and its data converter 86 is a DNEC—a micro-display such as DMD. Its package lid 8L comprises a transparent region 8G. The DMD chip 8C is placed in the same package with the DE2 chip 8A. It is stacked on top of the DE2 chip 8A and located directly below the transparent region 8G. Incoming light 78I is reflected and modulated by the DMD chip 8C. The outgoing light 78M is then projected onto a screen (to form images) or viewed through a personal viewer. Apparently, the bond wires 8W0, 8W1 (or solder bumps) in the single-package player 88P may be further protected by encapsulation with molding compound(s) 8MC. In a single-package player 88P, the DE2 chip 8A and DMD chip 8C are independently designed and manufactured. It has a lower overall system cost (because for the same die area, a DMD chip has higher value than a DE2 chip) and great product flexibility (the DE2 chip may be individually re-designed when, for example, a new video decoding standard is released). The single-package player is a practical content playback-unit with superior copyright protection.

FIG. 8 illustrates a chip/package-on-panel (CoP) player 88CoP. Because it is much larger than the DE2, a display panel is difficult to be housed with the DE2 in a package. In a CoP, a flipped DE2 (chip or package) 8E is directly mounted to the display panel 8D using solder bumps 8SB (bond wires may also be used). Encapsulation 8MC may be used to further enhance data protection. Because no un-protected PCB wires are used to make electrical connection, excellent copyright protection can also be achieved by the CoP player.

FIG. 9 illustrates a preferred content-delivery process (from a content provider 60 to a content user 50) and associated hardwares (including content server 60S on the provider side and content-playback system 90 on the user side). The content-delivery process includes: 1) content encryption and release; 2) content key delivery. During content encryption and release, the content server 60S encrypts contents 62o, and releases the encrypted contents 68o to a user 50 through electronic means or on a physical storage medium. Here, the electronic means could be internet, telephone line, coaxial cable, optical fiber, cellular telephone channel, broadcasting signals, and/or satellite signals; physical storage medium include tape, optical disk, magnetic disk, flash memory, and other semiconductor memories. Note that contents are released only in encrypted forms and therefore, the data transmission is secure. During content key delivery, a player ID 38 is sent to the content server 60S (through a first secure channel 38S); the content server 60S checks the player ID 38, if it belongs to an approved device (i.e. authorized to receive copyrighted contents, e.g. a tamper-proof device), the content server 60S will authorize the release of content key 660 to the player 90 (through a second secure channel 66S). Here, secure channels 38S, 66S conduct information exchange in encrypted forms. They are indicated by thick lines in FIG. 9 and figures thereafter. Both ends of a secure channel have an encrypter-decrypter combo (the encrypter encrypts outgoing information and the decrypter decrypts incoming information). It should be apparent to those skilled in the art that either symmetrical encryption or asymmetrical encryption may be used.

The content servers 60S authenticates player and encrypts contents. It is comprised of an authentication block 65, a content database 63, a key generator 66 and an encryption engine 68. The authentication block 65 comprises a list of approved devices. If a player ID matches one from the list, a content key is authorized to be released to said player. The content database 63 consists of a plurality of content files (62A, 62B . . . , files on the provider side) and their indices (64A, 64B . . . ). Based on the inputted file index (from user), a content file 620 (e.g. file 62B) is selected from the content database 63. The key generator 66 generates a content key 660 (possibly a random number). The encryption engine 68 then encrypts the content file 620 with the content key 660. The encrypted contents 680 are then released to the user 50 through electronic means or on a physical storage medium.

The player 90 further comprises a player ID 38 and a content-key table 31. The player ID is a unique number and is used by a content-key provider to identify if this player is an approved device (i.e. authorized to receive copyrighted contents, e.g. a tamper-proof device). It is preferably stored in a non-volatile memory in the content-playback unit 88. The content-key table 31 comprises a list of file indices (36A, 36B . . . , filed on the user side) and their associated content keys (32A, 32B . . . ). When a file (e.g. with index 36B) is selected for playback, its content key 32B is read out to decrypt the associated (encrypted) contents 80B. In this preferred embodiment, content keys are permanently stored inside the content-playback unit 88. They are preferably stored in a non-volatile memory therein.

The player ID 38 and content key 660 comprise highly-sensitive information. Loss of any of these numbers will severely compromise copyrights. Accordingly, they should be tightly guarded: during content key delivery, they should be transferred only in secure channels 38S, 66S (i.e. encrypted) and preferably decrypted only inside the content-playback unit 88; in the content-playback unit 88, only secure data connections are allowed between the storage of player ID 38 (or content-key table 31) and other portion of the content-playback unit (e.g. decryption engine 82). Preferably, the storage of player ID 38 (or content-key table 31) is embedded into the content-playback unit 88 (e.g. in a same chip or package). The player ID 38 and/or content keys (32A . . . ) may also be stored in encrypted forms.

Sometimes a user 50 may just want limited access to certain contents. Accordingly, conditional access is specified in DRM (digital rights management). As illustrated in FIG. 10A, usage permissions 110 specifies what a user 50 is allowed to do with contents; constraints 120 put restrictions on permissions 110. For example, a particular Mp3 file can be played (a usage permission 110) for a maximum of 5 times (a count constraint 122) in any month (a time constrain 124).

FIG. 10B illustrates a preferred tamper-proof content-playback system that provides conditional access to contents. Compared with FIG. 9, the content-key table 31 in the content-playback unit 88 further comprises an access tag column (34A, 34B . . . ). Each access tag contains the number of remaining accesses for an associated file. For example, 04H in access tag 34A means there remain 4 times of accesses for file 36A; 00H in 34B means there is no access for file 36B; FFH in 34C means there is un-limited access for file 36C (this can be defined by manufacturers). With the addition of access tag column, table 31 is referred hereinafter to as content-metadata table.

Besides content-metadata table 31, the content-playback unit 88 further comprises an access control block 33. When access to a file (e.g. 36B) is requested, the access control block 33 reads out its access tag 34B and disables or enables playback based on this value: in case of 00H, a “STOP” signal (33a, 33b) is sent to the decryption engine 82 (or data decompressor 84) and disables playback; in other cases, normal playback is enabled. After playback, the content control block 33 decreases the value of the access tag 34B by 1, if 00H<34o<FFH.

Besides conditional access, DRM also promotes fair-use rights for consumers. The fair-use rights dictate: a user can port contents (e.g. 80A, 80B . . . ) to multiple players (e.g. an Mp3 player 90A, and a car stereo 90B); and a player (e.g. 90A) can play contents from multiple users (e.g. contents 80A1, 80B1 from user 1; and contents 80A2, 80B2 from user 2) (FIG. 11A). The fair-use rights can also help to expedite adoption of new consumer devices.

FIG. 11B illustrates a tamper-proof content-playback system that protects the fair-use rights of consumers. Compared with FIG. 9, the content-metadata table 31 may be decoupled from the content-playback unit 88A and is located in a hot-key element 58. The hot-key element 58 may itself function as a player. It further comprises a user ID 52 and a player-ID table 35. The user ID 52 identifies the hot-key element 58 as a compliant device (i.e. safe to store content keys). The player-ID table 35 lists the player ID's (38A, 38B . . . ) of all players this hot-key element 58 can enable. Because it contains sensitive information, the hot-key element 58 is preferably implemented in a single chip and communicates with players and content servers through secure channels.

During content key delivery, the user ID 52 of the hot-key element 58 is first sent to the content server 60S for authentication (through a secure channel 52S. Secure channel is explained in FIG. 9). If the hot-key element 58 is a compliant device, the desired content key will be sent back to the hot-key element 58 (through a secure channel 66S), which is then saved to the content-metadata table 31. During content playback, the player ID 38 of a content-playback unit 88A is sent to each hot-key element 58 (through a secure channel 38S′). If it matches with one of these in the player-ID table 35 in a hot-key element 58, the content-metadata table 31 in said hot-key element 58 is searched. If a desired content key is found, it is then released to the player (through a secure channel 32S) and enables playback; if not found, the next hot-key element 58 will be inquired. Here, secure channels 38S′, 32S can use either wired means or wireless means. The wired means could use wired communication protocols such as USB, IEEE 1394. Here, wired means could be even used as a charging source for the battery carried by the hot-key element 58. The wireless means could also use wireless communication protocols such as Bluetooth, IEEE 802.11, UWB (ultra-wide band). Obviously, wireless secure channel offers great user convenience in this case.

Finally, applications of the tamper-proof content-playback system will be discussed. Although they all provide excellent copyright protection, the preferred embodiments disclosed in the present invention provides different levels of copyright protection. For example, the single-chip player in FIG. 6B provides the highest level of copyright protection. Accordingly, the content provider can adopt a preferential content-release model: contents released to single-chip players have the highest quality (better than those released to other players). This is realized by releasing the content keys associated with the highest quality contents only to the single-chip players, but not to others (by checking their respective player ID's).

While illustrative embodiments have been shown and described, it would be apparent to those skilled in the art that may more modifications than that have been mentioned above are possible without departing from the inventive concepts set forth therein. The invention, therefore, is not to be limited except in the spirit of the appended claims.

What is claimed is:

1. A tamper-proof content-playback system offering excellent copyright protection, comprising:
a content-storage function, at least a portion of contents stored in said content-storage function being encrypted;
a content-decrypting function for decrypting at least a portion of encrypted contents from said content-storage function to decrypted contents;
a data-converting function for converting at least a portion of decrypted contents into non-digital electrical content output(s) or non-electrical content output(s); and
secure data-connecting means between said content-decrypting function and said data-converting function for prohibiting ready external access to any form of decrypted contents.

2. The tamper-proof content-playback system according to claim 1, wherein said secure data-connecting means is selected from a group consisting of chip interconnects, bond wires, solder bumps, and protected PCB wires.

3. The tamper-proof content-playback system according to claim 1, further comprising a data-decompressing function between said content-decrypting function and said data-converting function.

4. The tamper-proof content-playback system according to claim 1, wherein said data-converting function is selected from a group consisting of digital-to-analog converter, digital-to-PWM converter, digital-to-PPM converter, analog copyright protection circuit, digital loudspeaker, digital light modulator, micro-display, digital micro-mirror device, liquid-crystal-on-silicon, scanned beam display, light-emitting diode array, display panel, liquid-crystal display, plasma display and organic light-emitting-diode display.

5. The tamper-proof content-playback system according to claim 1, further comprising at least an element selected from a group consisting of a player ID, an access control block, a content-key table and a content-metadata table.

6. The tamper-proof content-playback system according to claim 1, wherein said content-decrypting function and said data-converting function is located in a same chip.

7. The tamper-proof content-playback system according to claim 1, wherein said content-decrypting function and said data-converting function is located in a same package or chip/package-on-panel.

8. A tamper-proof content-playback system offering excellent copyright protection, comprising:
a player ID for a content-key provider to identify said content-playback system as an approved device;
a content-decrypting function for decrypting at least a portion of encrypted contents from said content-storage function to decrypted contents;
a data-converting function for converting at least a portion of decrypted contents into non-digital electrical content output(s) or non-electrical content output(s); and
secure data-connecting means between the storage of said player ID and said content-decrypting function and between said content-decrypting function and said data-converting function for prohibiting ready external access to any form of plaintext data.

9. The tamper-proof content-playback system according to claim 8, wherein said secure data-connecting means is selected from a group consisting of chip interconnects, bond wires, solder bumps, and protected PCB wires.

10. The tamper-proof content-playback system according to claim 8, further comprising a data-decompressing function between said content-decrypting function and said data-converting function.

11. The tamper-proof content-playback system according to claim 8, wherein said data-converting function is selected from a group consisting of digital-to-analog converter, digital-to-PWM converter, digital-to-PPM converter, analog copyright protection circuit, digital loudspeaker, digital light modulator, micro-display, digital micro-mirror device, liquid-crystal-on-silicon, scanned beam display, light-emitting diode array, display panel, liquid-crystal display, plasma display and organic light-emitting-diode display.

12. The tamper-proof content-playback system according to claim 8, further comprising at least an element selected from a group consisting of a content-storage function, an access control block, a content-key table and a content-metadata table.

13. The tamper-proof content-playback system according to claim 8, wherein said content-decrypting function and said data-converting function is located in a same chip.

14. The tamper-proof content-playback system according to claim 8, wherein said content-decrypting function and said data-converting function is located in a same package or chip/package-on-panel.

15. A hot-key element associated with at least one tamper-proof content-playback system, comprising:
a user ID for identifying said hot-key element to a content provider;
a content-metadata table for storing a plurality of contents keys; and
a player-ID table for storing a plurality of player ID's for the associated content-playback systems.

16. The hot-key element according to claim 15, wherein said hot-key element is implemented in a single chip.

17. The hot-key element according to claim 15, further comprising secure channel(s) for user ID, player ID and/or content keys, wherein said secure channel(s) conducts information exchange in encrypted forms.

18. The hot-key element according to claim 17, wherein said secure channel(s) uses at least one wired means.

19. The hot-key element according to claim 17, wherein said secure channel(s) uses at least one wireless means.

20. The hot-key element according to claim 15, further comprising a content-playback function for converting at least a portion of digital contents into non-digital electrical content output(s) or non-electrical content output(s).
